(19) United States
(12) Patent Application Publication
(10) Pub. No.: US 2019/0187591 A1
(43) Pub. Date: Jun. 20, 2019

(54) IMAGE FORMING APPARATUS

(71) Applicant: CANON KABUSHIKI KAISHA, Tokyo (JP)

(72) Inventor: Shoji Tanaka, Kawasaki-shi (JP)

(21) Appl. No.: 16/281,412

(22) Filed: Feb. 21, 2019

Related U.S. Application Data
(63) Continuation of application No. PCT/JP2017/032596, filed on Sep. 5, 2017.

(30) Foreign Application Priority Data
Sep. 5, 2016 (JP) 2016-172503

(51) Int. Cl. G03G 15/10; G03G 13/10; G03G 9/12

(52) U.S. Cl. CPC G03G 15/105; G03G 9/12; G03G 13/10

(57) ABSTRACT

A calculating portion 300 acquires resistance of a carrier liquid in a carrier tank. A resistance calculating portion 302 acquires the resistance of the carrier liquid on the basis of a “liquid amount of a carrier liquid for each of numbers of times of passing of the carrier liquid through a separation and extraction device” and “resistance of the carrier liquid for each of the numbers of times of passing of the carrier liquid through the separation and extraction device”. The “liquid amount of a carrier liquid for each of numbers of time of passing” is calculated by a deterioration degree distribution calculating portion 301 and is stored in a memory 201. As regards the “resistance of the carrier liquid for each of the numbers of times of passing”, the resistance of the carrier liquid after passing through the separation and extraction device is stored in the memory 201 in advance for each of the numbers of times of passing. A carrier supply discriminating portion 202 discriminates whether or not a carrier liquid for supply should be supplied, on the basis of the acquired resistance of the carrier liquid. A controller 200 controls a pump 51 for supply on the basis of this discrimination.

### TECHNICAL FIELD

The present invention relates to an electrophotographic image forming apparatus for forming an image with a liquid developer.

### BACKGROUND ART

Conventionally, the image forming apparatus for forming the image with the liquid developer containing toner and a carrier liquid has been known. The liquid developer is accommodated in a mixer and is supplied from the mixer to a developing device, and is subjected to development. Then, toner for supply is accommodated in a toner tank and a carrier liquid for supply is accommodated in a carrier tank, respectively, and the toner for supply and the carrier liquid for supply are supplied from the respective tanks to the mixer. The mixer mixes and disperses the toner in the carrier liquid and generates the liquid developer. In such an image forming apparatus, the liquid developer which is not used in the development is collected and recycled. In recycling of the liquid developer, toner which is a dispersoid in the liquid developer and the carrier liquid which is a dispersion medium in the liquid developer are separated, and the separated carrier liquid is sent to the carrier tank and is used again (Japanese Laid-Open Patent Application 2008-242436).

However, in the case where the liquid developer is repetitively recycled, with application of a high voltage, volume resistivity of the carrier liquid after separation lowers depending on an increase in amount of a charge control agent ionized from the toner in the carrier liquid after the separation (deterioration of the carrier liquid). When the carrier liquid lowered in volume resistivity (hereinafter simply referred to as resistance) is supplied to the mixer, the resistance of the liquid developer lowers. Then, when the liquid developer lowered in resistance is subjected to development, an image defect can be generated. Therefore, conventionally, the resistance of the carrier tank is detected using a resistance sensor and the carrier liquid for supply high in resistance is supplied on the basis of a detection value of the resistance sensor, and thus the resistance of the liquid developer was maintained in a predetermined range.

### Problem to be Solved by the Invention

As described above, the resistance of the carrier liquid is largely influenced by an amount of the charge control agent ionized from the toner. However, in the carrier liquid, in addition to the charge control agent, another substance, capable of fluctuating the resistance, such as a toner dispersing agent is contained. For that reason, conventionally, even when the carrier liquid for supply is supplied to the carrier tank on the basis of the detection value of the resistance sensor influence by the substance in addition to the charge control agent, the resistance of the carrier liquid cannot be improved, and as a result, it was difficult to maintain the resistance of the liquid developer in a predetermined range.

The present invention has been accomplished in view of the above-described problem, and aims at providing an image forming apparatus in which in a constitution re-using the carrier liquid, the volume resistivity of the carrier liquid is acquired by calculation without using the resistance sensor and supply control of the carrier liquid for supply is carried out on the basis of this.

### Means for Solving the Problem

According to an aspect of the present invention, there is provided an image forming apparatus comprising: an image forming portion for forming an image with a liquid developer containing toner and a carrier liquid; a separating device for separating the liquid developer collected from the image forming portion into the toner and the carrier liquid under application of a voltage; a toner container for accommodating toner for supply; a carrier container for accommodating the carrier liquid separated by the separating device; a mixing device for mixing the carrier liquid supplied from the carrier container with the toner for supply supplied from the toner container; a supplying device for supplying, to the carrier container, a carrier liquid for supply having a resistance value higher than a predetermined resistance value; a first supplying portion for supplying the liquid developer from the mixing device to the image forming portion; a second supplying portion for supplying the carrier liquid from the separating device to the carrier container; a calculating portion for calculating a value relating to volume resistivity of the carrier liquid in the carrier container on the basis of a supplying operation of the second supplying portion; and a controller for causing the supplying device to supply the carrier liquid for supply therefrom to the carrier container in order to adjust the volume resistivity of the carrier liquid in the carrier container on the basis of the value relating to the volume resistivity of the carrier liquid acquired by the calculating portion.

According to another aspect of the present invention, there is provided an image forming apparatus comprising: an image forming portion for forming an image with a liquid developer containing toner and a carrier liquid; a separating device for separating the liquid developer collected from the image forming portion into the toner and the carrier liquid under application of a voltage; a toner container for accommodating toner for supply; a carrier container for accommodating the carrier liquid separated by the separating device; a mixing device for mixing the carrier liquid supplied from the carrier container with the toner for supply supplied from the toner container; a supplying device for supplying, to the mixing device, a carrier liquid for supply; a first supplying portion for supplying the liquid developer from the mixing device to the image forming portion; a second supplying portion for supplying the carrier liquid from the separating device to the carrier container; a calculating portion for calculating a value relating to volume resistivity of the carrier liquid in the carrier container on the basis of a supplying operation of the second supplying portion; and a controller for causing the supplying device to supply the carrier liquid for supply therefrom to the mixing device in order to adjust the volume resistivity of the carrier liquid in the carrier container on the basis of the value relating to the volume resistivity of the carrier liquid acquired by the calculating portion.

### Effect of the Invention

According to the present invention, in the constitution re-using the carrier liquid, the volume resistivity of the carrier liquid depending on the number of times of drive of the second supplying portion is acquired by calculation and supply control of the carrier liquid for supply is carried out on the basis of this, and thus the volume resistivity of the liquid developer is easily maintained in a predetermined range.

### BRIEF DESCRIPTION OF THE DRAWINGS

FIG. 1 is a schematic view showing a structure of an image forming apparatus according to First Embodiment.

FIG. 2 is a schematic view showing a feeding path of a liquid developer in the image forming apparatus according to First Embodiment.

FIG. 3 is a control block diagram showing a supply control system of a carrier liquid for supply.

FIG. 4 is a flowchart showing a supply control process of the carrier liquid for supply.

FIG. 5 is a flowchart showing a process of calculating volume resistivity of a carrier liquid.

FIG. 6 is a view for illustrating a calculating method of the volume resistivity of the carrier liquid depending on the number of times of passing of the carrier liquid through a separation and extraction device.

FIG. 7 is a graph showing a carrier liquid amount for each of numbers of times of the passing of the carrier liquid through the separation and extraction device.

FIG. 8 is a view for illustrating a calculating method of the volume resistivity of the carrier liquid depending on the number of times of passing of the carrier liquid through the separation and extraction device and a developing device.

FIG. 9 is a graph showing a carrier liquid amount for each of numbers of times of the passing of the carrier liquid through the separation and extraction device and the developing device.

FIG. 10 is a schematic view showing a feeding path of a liquid developer in an image forming apparatus according to Second Embodiment.

### DESCRIPTION OF EMBODIMENTS

### First Embodiment

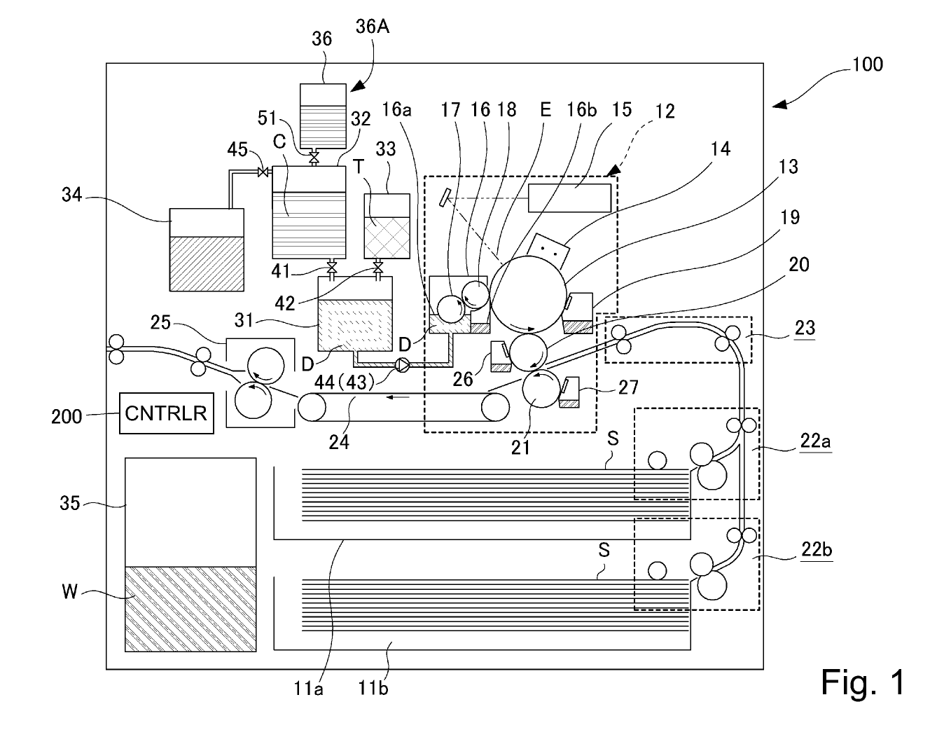

First embodiment of the present invention will be described using FIGS. 1-7. First, a general structure of an image forming apparatus in this embodiment will be described using FIG. 1.

### (Image Forming Apparatus)

An image forming apparatus 100 in this embodiment is a digital printer of an electrophotographic type in which a toner image is formed on a recording material S (a sheet, a sheet material such as an OHP sheet and so on). The image forming apparatus 100 is operated on the basis an image signal, and a toner image formed by an image forming portion 12 is transferred onto the sheet as the recording material successively fed from each of cassettes 11a, 11b and then is fixed on the recording material S, so that an image is obtained. The image signal is sent from an external terminal such as an unshown scanner or an unshown personal computer to the image forming apparatus 100.

The image forming portion 12 includes a photosensitive drum 13 as an image bearing member, a charger 14, a laser exposure device 15, a developing device 16 and a drum cleaner 19. A surface of the photosensitive drum 13 electrically charged by the charger 14 is irradiated with laser light E from the laser exposure device 15 depending on the first signal, so that an electrostatic latent image is formed on the photosensitive drum 13. This electrostatic latent image is developed as a toner image by the developing device 16. In this embodiment, in the developing device 16, a liquid developer D in which powdery toner which is a dispersoid is dispersed in a carrier liquid which is a dispersion medium is accommodated, and development is effected using this liquid developer D.

The liquid developer D is generated by mixing and dispersing toner T in a carrier liquid C in a predetermined ratio in a mixer 31 as a mixing device, and then is supplied to the developing device 16. The carrier liquid C is accommodated in a carrier tank 32 as a carrier container, and the toner T for supply is accommodated in a toner tank 33 as a toner container. Then, depending on a mixed state of the carrier liquid C and the toner T in the mixer 31, the carrier liquid C or the toner T is supplied from an associated tank toward the mixer 31. In the mixer 31, a stirring blade driven by an unshown motor is accommodated, and the developer liquid D is mixed with the carrier liquid C or the toner T by being stirred, so that the toner is dispersed in the carrier liquid.

The liquid developer supplied from the mixer 31 to the developing device 16 is coated (supplied) on a developing roller 18 by a coating roller 17 in a supplying section 16a of the developing device 16 and is used for development. The developing roller 18 carries and feeds the liquid developer D on a surface thereof, and develops with the toner the electrostatic latent image formed on the photosensitive drum 13 (image bearing member). The toner T and the carrier liquid C which remain on the developing roller 18 after the development is collected in a collecting section 16b of the developing device 16. Here, each of coating of the liquid developer from the coating roller 17 onto the developing roller 18 and the development of the electrostatic latent image on the photosensitive drum 13 by the developing roller 18 is made using an electric field.

The toner image formed on the photosensitive drum 13 is transferred onto an intermediary transfer roller 20 using the electric field, and then is fed to a nip formed by the intermediary transfer roller 20 and a transfer roller 21. The toner T and the carrier liquid C which remain on the photosensitive drum 13 after the toner image transfer onto the intermediary transfer roller 20 are collected by the drum cleaner 19. Incidentally, at least one of the intermediary transfer roller 20 and the transfer roller 21 may also be an endless belt.

The recording material S accommodated in each of the cassettes 11a, 11b is fed toward a registration feeding portion 23 by an associated feeding portion 22a or 22b constituted by feeding rollers. The registration feeding portion 23 feeds the recording material S to the nip between the intermediary transfer roller 20 and the transfer roller 21 by being timed to the toner image transferred on the intermediary transfer roller 20.

In the nip between the intermediary transfer roller 20 and the transfer roller 21, the toner image is transferred onto the recording material S passing through the nip, and the recording material S on which the toner image is transferred is fed to a fixing device 25 by a feeding belt 24, so that the toner image transferred on the recording material S is fixed. The recording material S on which the toner image is fixed is discharged to an outside of the image forming apparatus, so that an image forming step is completed.

The intermediary transfer roller 20 and the transfer roller 21 are provided with an intermediary transfer roller cleaner 26 and a transfer roller cleaner 27, respectively, for collecting the toner T and the carrier liquid C which remain on the associated roller.

### (Liquid Developer)

Next, the liquid developer develop will be described. As the liquid developer D, a conventionally used liquid developer may also be used, but in this embodiment, an ultraviolet-curable liquid developer D is used and will be described below.

The liquid developer D is an ultraviolet-curable liquid developer which contains a cation-polymerizable liquid monomer, a photo-polymerization initiator and toner particles insoluble in the cation-polymerizable liquid monomer. The cation-polymerizable liquid monomer is vinyl ether compound, and the photo-polymerization initiator is a compound represented by the following formula (Chem 1).

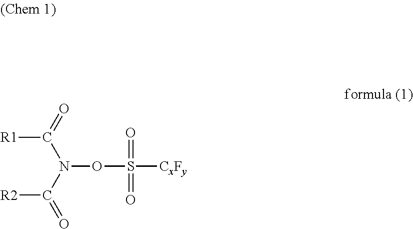

Specifically, first, the toner particles include a colorant and a toner resin material in which the colorant is incorporated. Together with the toner resin material and the colorant, another material such as a charge control agent may also be contained. As a manufacturing method of the toner particles, a well-known technique such as a coacervation in which the colorant is dispersed and a resin material is gradually polymerized so that the colorant is incorporated in the polymer or an internal pulverization method in which a resin material or the like is melted and the colorant is incorporated in the melted resin material may also be used. As the toner resin material, epoxy resin, styrene-acrylic resin or the like is used. The colorant may be a general-purpose organic or inorganic colorant. In the manufacturing method, in order to enhance a toner dispersing property, a dispersant is used but a synergist can also be used.

Next, a curable liquid which is the carrier liquid is constituted by the charge control agent for imparting electric charges to the toner surface, a photo-polymerization agent (initiator) for generating acid by ultraviolet (UV) irradiation and a monomer bondable by the acid. The monomer is a vinyl ether compound which is polymerizable by a cationic polymerization reaction. Separately from the photo-polymerization initiator, a sensitizer may also be contained. By photo-polymerization, a storage property lowers, and therefore a cationic polymerization inhibitor may also be added in an amount of 10-5000 ppm. In addition, a charge control aid, another additive or the like may also be used in some cases.

The UV curing agent (monomer) of the developer is a mixture of about 10% (weight %) of a monofunctional monomer having one vinyl ether group represented by a chemical formula (Chem 2 below) and about 90% (weight %) of difunctional monomer having two vinyl ether groups (represented by a chemical formula (Chem 3 below).

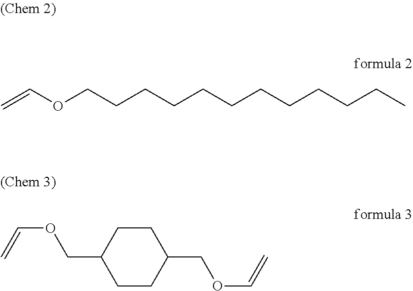

As the photo-polymerization initiator, 0.1% of a compound represented by (Chem 4) below is mixed. By using this photo-polymerization initiator, different from the case where an ionic photo-acid generator, a high-resistance liquid developer is obtained while enabling satisfactory fixing.

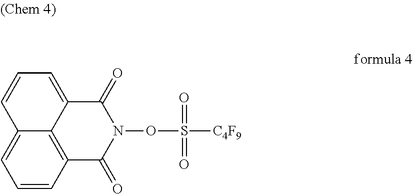

Incidentally, a cationic polymerizable liquid monomer may desirably be a compound selected from the group consisting of dichloropendadiene vinyl ether, cyclohexanedimethanol divinyl ether, tricyclodecane vinyl ether, trimethylolpropane trivinyl ether, 2-ethyl-1,3-hexamediol divinyl ether, 2,4-diethyl-1,5-pentanediol divinyl ether, 2-butyl-2-ethyl-1,3-propanediol divinyl ether, neopentylglycol divinyl ether, pentaerythritol tetravinyl ether, and 1,2-decanediol divinyl ether.

As the charge control agent, a well-known compound can be used. As a specific example, it is possible to use fats and oils such as linseed oil and soybean oil; alkyd resin; halogen polymer; oxidative condensates such as aromatic polycarboxylic acid, acidic group-containing water-soluble dye and aromatic polyamine; metallic soaps such as cobalt naphthenate, nickel naphthenate, iron naphthenate, zinc naphthenate, cobalt octylate, nickel octylate, zinc octylate, cobalt dodecylate, nickel dodecylate, zinc dodecylate, aluminum stearate, and cobalt 2-ethylhexylate; sulfonic acid metal salts such as petroleum acid metal salt and metal salt of sulfosuccinic acid; phospholipid such as lectithin; salicylic acid metal salt such as t-butylsalicylic acid metal complex; polyvinyl pyrrolidone resin; polyamide resin; sulfonic acid-containing resin; and hydroxybenzoic acid derivative.

### (Feeding of Liquid Developer)

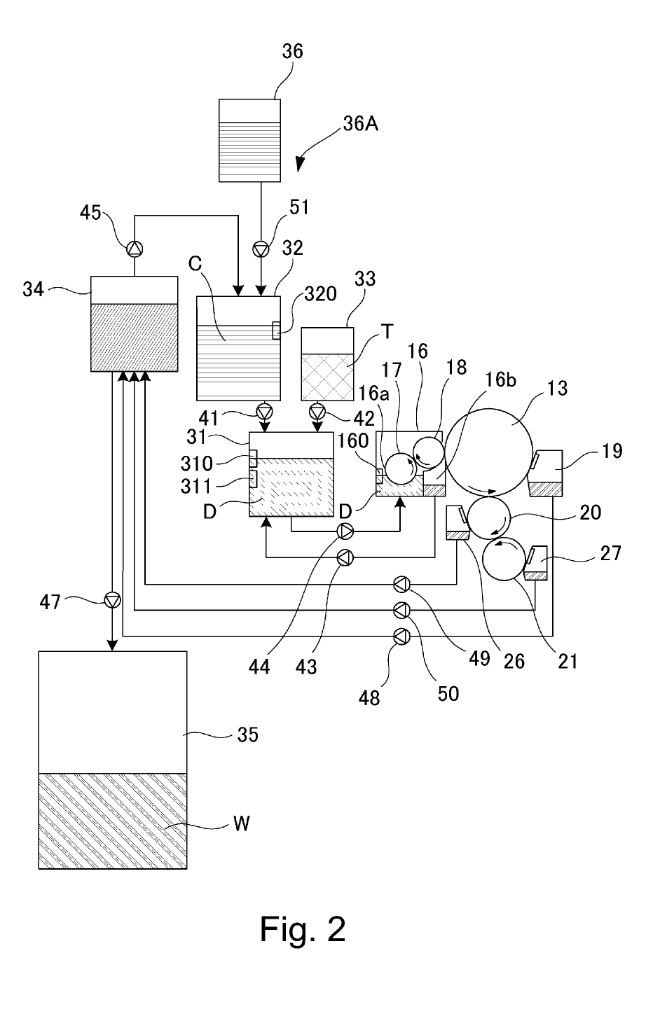

Next, feeding of the liquid developer D in this embodiment will be described using FIG. 2. A transporting pipe from the carrier tank 32 to the mixer 31 and a transporting pipe from the toner tank 33 to the mixer 31 are provided with a carrier supplying pump 41 and a toner supplying pump 42, respectively, and a supply amount of the carrier liquid C to the mixer 31 and a supply amount of the toner T to the mixer 31 are adjusted. From the mixer 31, the liquid developer D necessary for the development is supplied to the developing device 16 by a developer supplying pump 44 as a first supplying portion. The developing device 16 is provided with a developer amount detecting device 160, and the developer amount detecting device 160 detects an amount of the liquid developer D in the developing device 16. Supply of the liquid developer D to the developing device 16 is carried out so that a detection value of the developer amount detecting device 160 is not less than a predetermined value (for example 200 ml). Then, the liquid developer D which remains on the developing roller 18 after the development and which is collected into a collecting section 16b of the developing device 16 is returned to the mixer 31 by a circulating pump 43 as a returning portion, and is used again. Incidentally, the liquid developer D collected into the collecting section 16b of the developing device 16 may also be fed to the separation and extraction device 34.

As described above, the toner T and the carrier liquid C which are collected by the drum cleaner 19, the intermediary transfer roller cleaner 26 and the transfer roller cleaner 27 are fed to the separation and extraction device 34 as a separating device by pumps 48, 49 and 50, respectively. The separation and extraction device 34 is separates the toner T and the carrier liquid C by an electrolytic parting system, and makes the carrier liquid re-usable.

The separation and extraction device 34 separates the liquid developer into the re-usable carrier liquid and waste fluid W containing impurities such as the toner and paper powder. The re-usable carrier liquid separated by the separation and extraction device 34 is fed to the carrier tank 32 by a separation and collection pump 45 as a second supplying portion. On the other hand, the separated waste fluid W is fed to a waste fluid collecting container 35 by a pump 47 provided to a transporting pipe.

In the carrier tank 32, a float sensor 320 as a liquid amount detecting portion for detecting a liquid amount of the carrier liquid in the carrier tank 32 is provided. In this embodiment, the carrier tank 32 is provided with only the float sensor 320 but is not provided with a resistance sensor for detecting the volume resistivity (resistance) of the carrier liquid. The float sensor 320 detects a position (liquid level) of a float floated on a liquid surface, and thus detects the liquid amount in the carrier tank 32. As the float sensor 320, for example, a float sensor in which a float provided with a magnet and a reed switch are provided and a position of the float is detected by the reed switch is used. Incidentally, the liquid amount detecting portion is not limited to the float sensor 320.

### [Supply of Carrier Liquid]

In this embodiment, a supplying device 36A for supplying the carrier liquid for supply is provided. The supply of the carrier liquid for supply by the supplying device 36A is controlled by a controller 200 (see FIG. 1) as a controller. The supplying device 36A includes a supplying carrier tank 36 and a supplying pump 51 provided to a communicating pipe communicating the supplying carrier tank 36 with the carrier tank 32. In the supplying carrier tank 36, the carrier liquid for supply having relatively high resistance of not less than 1.0E+14 Ωcm in resistance is accommodated. This carrier liquid for supply is higher in resistance than the carrier liquid which is separated and extracted by the separation and extraction device 34 and which is sent to the carrier tank 32, and is higher in resistance than the carrier liquid used at the image forming portion 12.

The supplying device 36A is capable of supplying the carrier liquid for supply on the basis of the liquid amount of the carrier liquid in the carrier tank 32 (in the carrier container). Specifically, in the case where the liquid amount of the carrier liquid in the carrier tank 32 is detected as being a predetermined value or less by the float sensor 320, the supplying pump 51 is driven, so that the carrier liquid for supply is supplied from the supplying carrier tank 36 to the carrier tank 32.

Further, the supplying device 36A is capable of supplying the carrier liquid for supply on the basis of the resistance of the carrier liquid in the carrier tank 32. In the case of this embodiment, the resistance of the carrier liquid in the carrier tank 32 is acquired by calculation, and in the case where the resistance of this carrier liquid is lower than the predetermined value, the supplying pump 51 is driven, so that the carrier liquid for supply is supplied from the supplying carrier tank 36 to the carrier tank 32.

### [With Regard to Deterioration of Carrier Liquid]

On the surface of the toner in the liquid developer, the charge control agent of a polarity opposite to a polarity of a surface potential of the toner exists. Further, as regards the liquid developer subjected to development by the developing device 16, the toner and the charge control agent are ionized in response to application of a high voltage during the development. Most of the toner in the liquid developer is consumed with the development, but the charge control agent is little consumed, and therefore, the charge control agent is liable to remain in the liquid developer. The resistance of this charge control agent is for example about 1.0E+9 Ωcm, and therefore, the liquid developer repetitively used is lowered in resistance compared with the liquid developer before repetitively used. Thus, when the liquid developer (deteriorated liquid developer) containing a large amount of the ionized charge control agent is used again as it is, the image defect is liable to generate.

As described above, the liquid developer collected by the drum cleaner 19, the intermediary transfer roller cleaner 26 and the transfer roller cleaner 27 is separated into the carrier liquid and the waste fluid by the separation and extraction device 34. In the separation and extraction device 34, when the liquid developer is separated into the carrier liquid and the waste fluid, the high voltage is applied to the liquid developer. That is, also during the recycling of the liquid developer, the toner and the charge control agent are ionized. Then, even when the liquid developer is separated into the carrier liquid and the waste fluid, the charge control agent remains in the carrier liquid. Therefore, the charge control agent increases in amount in the carrier liquid separated by the separation and extraction device 34, and correspondingly thereto, the resistance of the carrier liquid in the carrier tank 32 lowers.

The resistance of the carrier liquid in the carrier tank 32 can be increased only by the above-described supply of the carrier liquid for supply. By the supply of the carrier liquid for supply, a relative amount occupied by the charge control agent in the carrier liquid decreases, so that the resistance of the carrier liquid increases.

Incidentally, conventionally, in order to improve the resistance of the carrier liquid, the carrier tank 32 was provided with a resistance sensor, and in the case where a detection value (sensor value) of the resistance sensor was smaller than a predetermined value, the supplying device 36A was controlled, and thus supply of the carrier liquid for supply was carried out. The resistance sensor detects an electric resistance at that time by providing a pair of electrodes in the liquid developer and by causing a current to pass through the electrodes, for example. Therefore, a detection value of the resistance sensor can fluctuate by the influence of not only the charge control agent in the carrier liquid but also another substance such as the toner dispersant. However, the resistance sensor detects only the resistance of an entirety of the carrier liquid and cannot detect an amount of the charge control agent contained in the carrier liquid and an amount of another substance such as the toner dispersant. For that reason, even when sensor amounts are the same, amounts of the charge control agents contained in the carrier liquids are not always the same. Although the amounts of the charge control agents contained in the carrier liquids may be not the same when the supply of the carrier liquid for supply is carried out on the basis of the sensor values, a variation (error) can occur in resistance of the carrier liquids after the supply of the carrier liquid for supply. Thus, in the case where the resistance sensor is used, a change in resistance depending on the amount of the charge control agent contained in the carrier liquid cannot be properly grasped. For that reason, the carrier liquid for supply is supplied, and even when the sensor value exceeds the predetermined value, the resistance of the liquid developer in the mixer 31 to which the carrier liquid is supplied from the carrier tank 32 was not improved, so that the image defect continuously generated in some instances.

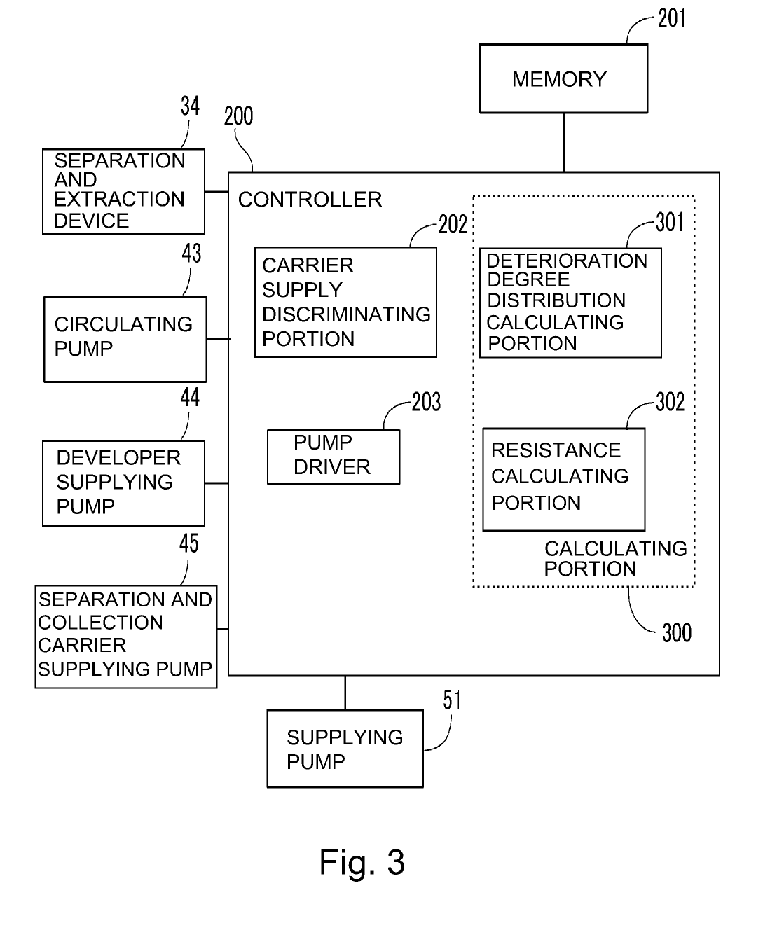

In this embodiment, in view of the above point, the resistance of the carrier liquid in the carrier tank 32 was acquired by calculation without using the resistance sensor, and the supplying device 36A was controlled on the basis of this, so that supply of the carrier liquid for supply was enabled. In the following, supply control of the carrier liquid for supply will be described with reference to FIG. 3 to FIG. 6 while appropriately making reference to FIG. 1 and FIG. 2.

### [Controller]

The image forming apparatus 100 of this embodiment includes the controller 200 as the controller. With the controller 200, as shown in FIG. 3, the memory 201, the separation and extraction device 34, the circulating pump 43, the developer supplying pump 44, the separation and collection pump 45, the supplying pump 51 and the like are connected. Incidentally, with the controller 200, in addition to the illustrated members, various devices and various sensors, such as the image forming portion 12, the float sensor 320, another pump, motor, high voltage source and the like are connected, but are omitted from illustration and description in this embodiment.

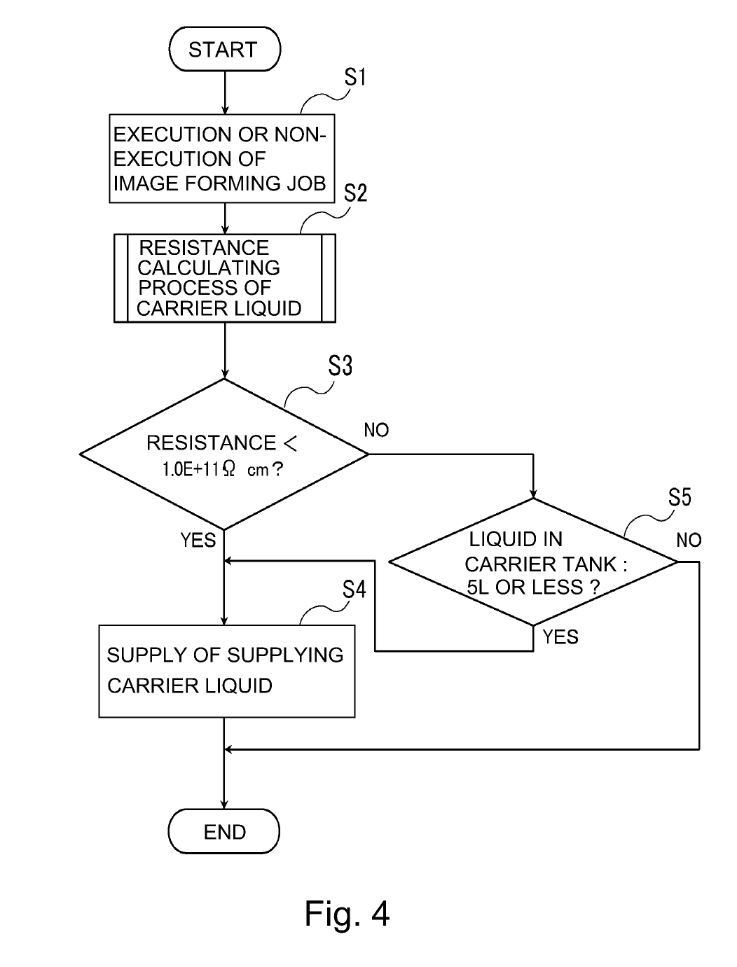

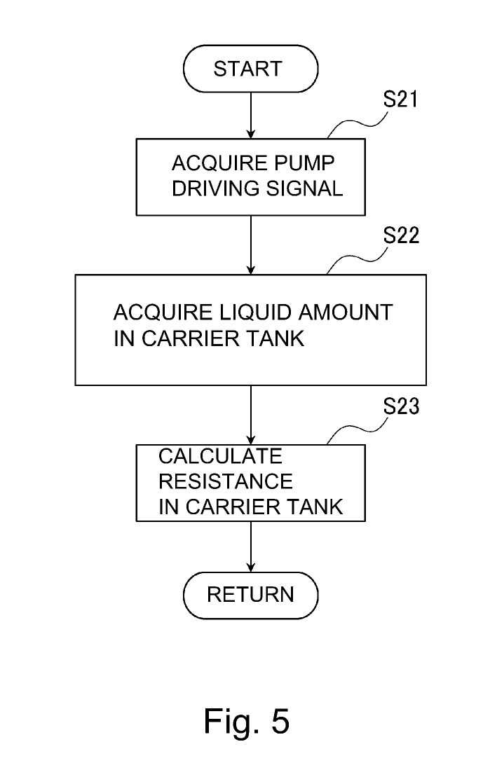

The controller 200 is for example a CPU (Central Processing Unit) or the like for carrying out various pieces of control of the image forming apparatus 100, such as an image forming operation. The memory 201 is a storing portion such as an ROM, an RAM or a hard disk device. In the memory 201, various control programs, data and the like for controlling the image forming apparatus 100 are stored. The controller 200 executes an image forming job (image forming program) stored in the memory 201 and causes the image forming apparatus 100 to carry out image formation. Further, the controller 200 executes a supply control process (see FIGS. 4 and 5 described later) of the carrier liquid for supply stored in the memory 201 and causes the image forming apparatus 100 (specifically the supplying device 36A) to perform the supply of the carrier liquid for supply. In the case of this embodiment, the controller 200 causes the supplying device 34A to operate in the case where the number of times per unit time of drive of the separation and collection pump 45 is large. Incidentally, the memory 201 is capable of temporarily storing a calculation process result or the like with execution of the various control programs.

Here, the image forming job is a series of operations from a start of the image formation until the image forming operation is completed, on the basis of a print signal for forming the image on the recording material S. That is, the image forming job is a series of operations from a start of a preparatory operation (so-called a pre-rotation operation) required for carrying out the image formation until a preparatory operation (so-called a post-rotation) required for ending the image formation toner the image forming step. Specifically, the image forming job refers to the operations from the time of the pre-rotation (preparatory operation before the image formation) after receiving the print signal (input of the image forming job) to the post-rotation (operation after the image formation), and includes an image forming period and a sheet interval.

The controller 200 can be largely divided into a carrier supply discriminating portion 202, a pump driver 203 and a calculating portion 300. The carrier supply discriminating portion 202 discriminates whether or not the carrier liquid for supply should be supplied to the carrier tank 32 on the basis of the resistance of the carrier liquid in the carrier tank 32. The controller 200 controls the supplying pump 51 on the basis of this discrimination. The controller 200 controls the supplying pump 51, the circulating pump 43, the developer supplying pump 44, the separation and collection pump 45 and further another pump through the pump driver 203. In the case of this embodiment, the controller 200 counts the number of times of drive of each of the pumps and causes the memory 201 to store counted values.

The calculating portion 300 as a calculating portion is divided into a deterioration degree distribution calculating portion 301 and a resistance calculating portion 302. In this embodiment, as the resistance of the carrier liquid used when the carrier supply discriminating portion 202 discriminates whether or not the carrier liquid for supply should be supplied, resistance acquired by the calculating portion 300 is used. Although description will be made specifically later, the resistance calculating portion 302 acquires the resistance of the carrier liquid in the carrier tank 32 on the basis of a “liquid amount of the carrier liquid for each of numbers of times of passing of the carrier liquid through the separation and extraction device 34” and “resistance of the carrier liquid for each of numbers of times of passing of the carrier liquid through the separation and extraction device 34”. The above-described “liquid amount (of the carrier liquid) for each of numbers of times of passing” is calculated by the deterioration degree distribution calculating portion 301 and is stored in the memory 201. On the other hand, as regards the above-described “resistance (of the carrier liquid) for each of numbers of times of passing”, the resistance of the carrier liquid after passing through the separation and extraction device 34 is stored in the memory 201 in advance for each of numbers of times of the passing. This is acquired by an experiment.

### [Supply Control Process]

FIG. 4 shows a supply control process of the carrier liquid for supply executed by the controller 200. This process is repetitively executed, for example, for each 100 milliseconds so long as the image forming job is carried out. As shown in FIG. 4, the controller 200 detects the presence or absence of execution of the image forming job (S1). Then, the controller 200 executes process of a “carrier liquid resistance calculating process” (S2) and later in synchronism with the execution of the image forming job, i.e., during the operation of the image forming apparatus 100. As described later (see FIG. 5), in the “carrier liquid resistance calculating process”, every drive of the separation and collection pump 45 during the execution of the image forming job, the resistance of the carrier liquid in the carrier tank 32 is acquired by calculation. “Carrier liquid resistance calculating process”

(S2 of FIG. 4) will be described using FIG. 5. The deterioration degree distribution calculating portion 301 counts, every drive of the separation and collection pump 45, the number of times of drive of the separation and collection pump 45 on the basis of a pump driving signal acquired from the pump driver 203 and causes the memory 201 to store counted values (S21). In this embodiment, the case where the separation and collection pump 45 feed a predetermined amount of the carrier liquid to the carrier tank 32 is counted as one time of drive of the separation and collection pump 45. Further, the deterioration degree distribution calculating portion 301 acquires the liquid amount of the carrier liquid in the carrier tank 32 from the float sensor 320 (S22). Then, the deterioration degree distribution calculating portion 301 calculates, every one drive of the separation and collection pump 45 (every one passing of the carrier liquid through the separation and extraction device 34), the “liquid amount (of the carrier liquid) for each of numbers of times of passing” in which the carrier liquid in the carrier tank 32 passes through the separation and extraction device 34. For example, the deterioration degree distribution calculating portion 301 calculates a “liquid amount by passing of one time” in the case where the separation and collection pump 45 is driven one time, calculates the “liquid amount by passing of one time” and “liquid amount by passing of two times” in the case where the separation and collection pump 45 is driven two times, and calculates the “liquid amount by passing of one time”, the “liquid amount by passing of two times” and a “liquid amount by passing of three times” in the case where the separation and collection pump 45 is driven three times. As described above, in the case, the “number of times of passing (number of passing times)” of the carrier liquid through the separation and extraction device 34 is grasped by the number of times of passing of the carrier liquid through the separation and collection pump 45.

### [Calculation of Liquid Amount for Each Number of Times of Passing]

A calculating method of the “liquid amount for each number of times of passing” will be described by a calculation mold. As a calculation model, a matrix C with one row and n columns, in which the liquid amount of the carrier liquid in the carrier tank 32 is assigned is used. At first row and first column of the matrix C, as a “liquid amount by passing of no time (in an initial state of no passing” in which the carrier liquid does not pass through the separation and collection pump 45 even one time, an entire amount of the carrier liquid amount in the carrier tank 32 is assigned. Then, every time when the separation and collection pump 45 is driven one time (every time when the carrier liquid passes through the separation and extraction device 34 one time, the “liquid amount for each number of times of passing” is successively assigned for elements moving the columns. For example, when the separation and collection pump 45 is driven two times, the “liquid amount by passing of no time” for the first row and first column, the “liquid amount by passing of one time” for the first row and second column and the “liquid amount by passing of two times” for the first row and third column and successively assigned. The sum of the elements of the matrix C is coincident with a total liquid amount of the carrier liquid in the carrier tank 32. Incidentally, the liquid amount of the carrier liquid may preferably be calculated using a volume (ml or cc) rather than a weight from a viewpoint of decreasing a calculation load.

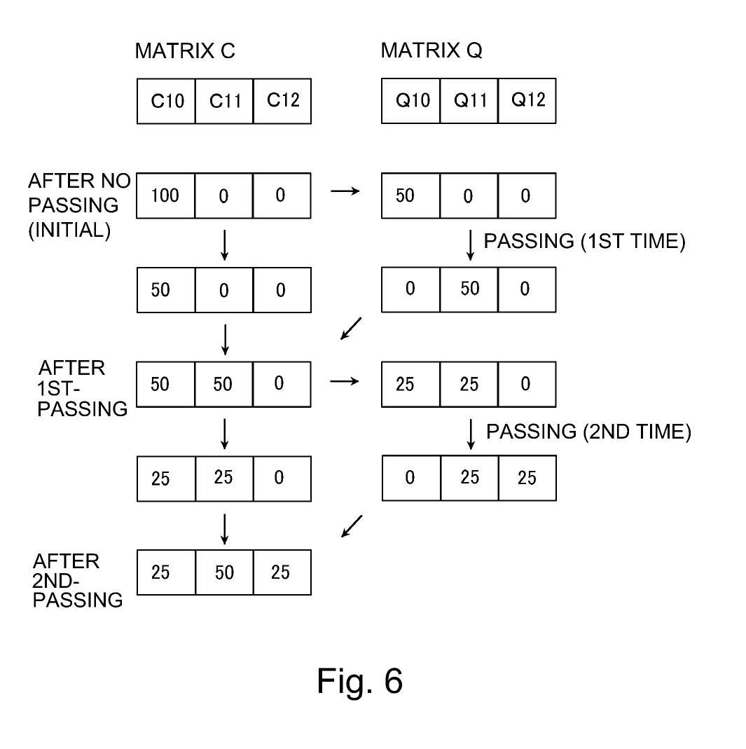

This will be specifically described using FIG. 6. In this embodiment, the case where the separation and collection pump 45 is driven two times will be described. Incidentally, as a calculation model, the liquid amount of the carrier liquid flowing from the separation and extraction device 34 with single drive of the separation and collection pump 45 and the liquid amount of the carrier liquid contained in the liquid developer flowing into the separation and extraction device 34 by the pumps 48, 49 and 50 at that time are equal to each other. That is, the carrier liquid amount does not increase and decrease before and after the drive of the separation and collection pump 45. Further, the liquid amount (feeding amount) of the carrier liquid fed by the single drive of the separation and collection pump 45 is 50 ml, and the liquid amount of the carrier liquid contained in the carrier tank 32 is 100 ml. Of course, these numerical values are an example for explanation and are not limited thereto.

The “liquid amount by passing of no time”, the “liquid amount by passing of one time” and the “liquid amount by passing of two times” are represented by C10, C11 and C12, respectively. In the case where the separation and collection pump 45 is not driven even once, the respective elements of the matrix C can be represented by formula 1 to formula 3. In this embodiment, the matrix C is “100, 0, 0” (after passing of no time (during initial state) “AFTER NO PASSING (INITIAL)” of FIG. 6).

C[1,1]=C10=100 formula 1

C[1,2]=C11=0 formula 2

C[1,3]=C12=0 formula 3

By the first drive of the separation and collection pump 45, the respective elements of the matrix C changes depending on calculation of formula 4 to formula 6. The formula 4 to 6 represent, of a liquid amount R (feeding amount of the separation and collection pump 45) of the carrier liquid passing through the separation and extraction device 34 depending on the single drive of the separation and collection pump 45, the “liquid amount by passing of no time”, the “liquid amount by passing of one time” and the “liquid amount by passing of two times” as Q10, Q11 and Q12. The liquid amounts Q10 to Q12 constitute a matrix Q “50, 0, 0”. The above Q10 to Q12 are assigned to first row and first column to first row and third column as shown in FIG. 6.

Q10=R×C10/(C10+C11+C12)=50×100/100=50 formula 4

Q11=R×C11/(C10+C11+C12)=50×0/100=0 formula 5

Q12=R×C12/(C10+C11+C12)=50×0/100=0 formula 6

Then, with first passing of the carrier liquid through the separation and extraction device 34, the respective elements of the matrix Q “50, 0, 0” are moved row by row, so that a matrix Q “0, 50, 0” is provided. This is accommodated again in the carrier tank 32, so that the respective elements of the matrix C after the single drive of the separation and collection pump 45 can be represented by formula 7 to formula 9.

C[1,1]=C10−Q10=100−50=50 formula 7

C[1,2]=C11−Q11+Q10=0−0+50=50 formula 8

C[1,3]=C12−Q12+Q11=0−0+0=0 formula 9

The matrix C “50, 50, 0” after the single drive of the separation and collection pump 45 (after passing of one time “AFTER 1ST-PASSING” of FIG. 6) represents that of the carrier liquid in the carrier tank 32, the “liquid amount by passing of no time” is 50 ml, the “liquid amount by passing of one time” is 50 ml, and the “liquid amount by passing of two times” is 0 ml. That is, when the separation and collection pump 45 is driven one time, 50 ml of the carrier liquid which has not been fed to the separation and extraction device 34 remains as the “liquid amount by passing of no time” in the carrier tank 32, and 50 ml of the carrier liquid fed to the separation and extraction device 34 is accommodated again as the “liquid amount by passing of one time” in the carrier tank 32.

Although description will be omitted, the respective elements of the matrix C after the second drive of the separation and collection pump 45 are similarly represented by formula 11 to formula 13 (matrix C “25, 50, 25”, after passing of two times, “AFTER 2ND-PASSING” of FIG. 6).

C[1,1]=C10−Q10=50−25=25 formula 11

C[1,2]=C11−Q11+Q10=50−25+25=50 formula 12

C[1,3]=C12−Q12+Q11=0−0+25=25 formula 13

Here, Q10 to Q12 are acquired by the following formula 14 to formula 16.

Q10=R×C10/(C10+C11+C12)=50×50/100=25 formula 14

Q11=R×C11/(C10+C11+C12)=50×50/100=25 formula 15

Q12=R×C12/(C10+C11+C12)=50×0/100=0 formula 16

The matrix C “25, 50, 25” represents, as a breakdown of the carrier liquid in the carrier tank 32, that the “liquid amount by passing of no time” is 25 ml, the “liquid amount by passing of one time” is 50 ml, and the “liquid amount by passing of two times” is 25 ml. That is, during the second drive of the separation and collection pump 45, of 100 ml of the carrier liquid containing 50 ml which is the “liquid amount by passing of no time” and 50 ml which is the “liquid amount by passing of one time”, 50 ml of the carrier liquid is fed. In the carrier tank 32, the “liquid amount by passing of no time” of the carrier liquid and the “liquid amount by passing of one time” of the carrier liquid exist in mixture, so that of 50 ml of the carrier liquid to be fed, 25 ml is the “liquid amount by passing of no time” and remaining 25 ml is the “liquid amount by passing of one time” (matrix Q “25, 25, 0”). If so, also as regards 50 ml of the carrier liquid remaining in the carrier tank 32, the “liquid amount by passing of no time” is 25 ml and the “liquid amount by passing of one time” is 25 ml (matrix C “25, 25, 0”).

The carrier liquid in 50 ml passes through the separation and extraction device 34, so that the “liquid amount by passing of one time” is 25 ml and the “liquid amount by passing of two times” is 25 ml, and the carrier liquid returns to the carrier tank 32 (matrix Q “0, 25, 25”). Further, as described above, in the carrier tank 32, 25 ml which is the “liquid amount by passing of no time” of the carrier liquid and 25 ml which is the “liquid amount by passing of one time” of the carrier liquid remain. Therefore, in the carrier tank 32 after the second drive of the separation and collection pump 45, the carrier liquid in which 25 ml which is the “liquid amount by passing of no time” of the carrier liquid, 50 ml which is the “liquid amount by passing of one time” of the carrier liquid and 25 ml which is the “liquid amount by passing of two times” of the carrier liquid exist in mixture is accommodated (matrix C “25, 50, 25”).

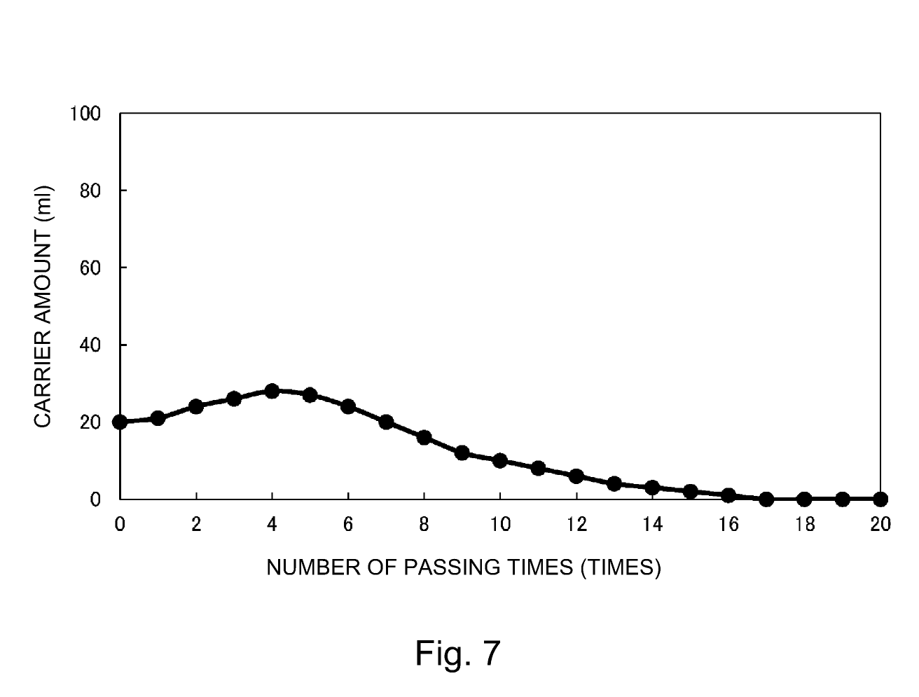

In the above-described manner, calculation of the “liquid amount for each number of times of passing” of the carrier liquid contained in the carrier liquid in the carrier tank 32 is performed every time when the separation and collection pump 45 is driven once (every time when the carrier liquid passes through the separation and extraction device 34 once). In FIG. 7, an example of the “liquid amount for each number of times of passing (NUMBER OF PASSING TIMES (TIMES))” in the case where the separation and collection pump 45 is driven twenty times is shown.

The “liquid amount for each number of times of passing” shown in FIG. 7 represents as a whole a distribution such that how many amount of the carrier liquid which has passed through the separation and extraction device 34 what times exists in the carrier tank 32. As has already been described above, also when the liquid developer is separated into the carrier liquid and the waste fluid by the separation and extraction device 34, the relative amount occupied by the charge control agent in the carrier liquid increases (the carrier liquid deteriorates). That is, with a larger number of times of drive (number of times of passing) of the separation and collection pump 45, the carrier liquid is more conspicuous in deterioration. As can be understood from FIG. 7, in the case where the carrier liquid is passed through the separation and extraction device 34, a proportion occupied by the deteriorated carrier liquid decreases with four times as a peak.

### [Calculation of Resistance of Carrier Liquid]

Returning to FIG. 5, the resistance calculating portion 302 acquires the resistance of the carrier liquid in the carrier tank 32 with the “liquid amount of each number of times of passing” calculated by the deterioration degree distribution calculating portion 301 (S23). The resistance of the carrier liquid under application of a high voltage has already been stored in advance in the memory 201 for each of numbers of times of passing of the carrier liquid through the separation and extraction device 34. The resistance of the carrier liquid is proportional to the number of times of passing of the carrier liquid through the separation and extraction device 34 and is lowered to for example 1/2 of the resistance of the carrier liquid before passing of the carrier liquid for each (single) passing. Specifically, in the case where the resistance of the carrier liquid which has passed through the separation and extraction device 34 no time is “1.0E+14 Ωcm”, the resistance after single passing is “0.5E+14 Ωcm”, and the resistance after passing of two times is “0.25E+14 Ωcm”. Accordingly, as described above, the “liquid amount for each number of times of passing” is for example represented by the above-described formula 11 to formula 13 (matrix C “25, 50, 25” of FIG. 6), the resistance of the carrier liquid is acquired by formula 17 shown below.

(1.0E+14×25+0.5E+14×50+0.25E+14×15)/(25+50+25)=0.5625E+14 formula 17

Returning to FIG. 4, the controller 200 executes a “carrier liquid resistance calculating process” (S2), and thereafter discriminates whether or not the calculated resistance (resistance calculation result) of the carrier liquid is smaller than a predetermined value (for example, 1.0E+11 Ωcm) (S3). In the case where the controller 200 discriminated that the resistance calculation result is smaller than the predetermined value (YES of S3), the controller 200 causes the supplying pump 51 to be driven for a predetermined time in order to supply a predetermined amount of the carrier liquid for supply (S4). That is, in this case, small resistance of the carrier liquid means that the carrier liquid is large in amount of the charge control agent, so that in order to reduce the relative amount occupied by the charge control agent in the carrier liquid, the controller 200 carries out control of supplying the carrier liquid for supply. Thereafter, the controller 200 ends this supply control process.

On the other hand, in the case where the controller 200 discriminated that the resistance calculation result is the predetermined value or more (NO of S3), on the basis of a detection result of the float sensor 320, the controller 200 discriminates whether or not the liquid amount of the carrier liquid in the carrier tank 32 is not more than a predetermined value (for example, five litters) (S5). In the case where the controller 200 discriminated that the liquid amount of the carrier liquid is larger than the predetermined value (NO of S5), the controller 200 ends this supply control process. In this case, the carrier liquid has sufficiently high resistance, i.e., a good carrier liquid small in amount of the charge control agent, and also the liquid amount is sufficiently ensured, so that the carrier liquid for supply is not supplied. In the case where the controller 200 discriminated that the liquid amount of the carrier liquid is the predetermined value or less (YES of S5), the controller 200 causes the supplying pump 51 to be driven for a predetermined time in order to supply a predetermined amount of the carrier liquid for supply (S4). Thereafter, the controller 200 ends this supply control process.

As described above, in this embodiment, the resistance of the carrier liquid used when the carrier supply discriminating portion 202 discriminates whether or not the carrier liquid for supply should be supplied is acquired by calculation. Further, the resistance of the carrier liquid is acquired on the basis of a “liquid amount of the carrier liquid for each of numbers of times of passing of the carrier liquid through the separation and extraction device 34” and “resistance of the carrier liquid for each of numbers of times of passing of the carrier liquid through the separation and extraction device 34”. According to this, in the resistance acquired by calculation, a fluctuation in resistance due to the ionized charge control agent contained in the carrier liquid is reflected. Therefore, compared with the case where the resistance sensor is used, a variation (error) in resistance of the carrier liquid after the carrier liquid for supply is supplied does not readily occur. Accordingly, supply control of the carrier liquid for supply is carried out on the basis of the resistance acquired by calculation, whereby the resistance of the liquid developer can be maintained in a predetermined range. When the resistance of the liquid developer can be maintained in the predetermined range, the image defect does not readily generate.

Incidentally, implementation of ionization of the charge control agent was made not only during separation and extraction of the carrier liquid but also during development has already been described. Further, in the developing device 16, of the liquid developer supplied from the mixer 31 by the developer supplying pump 44, the liquid developer which was not used for the development is returned to the mixer 31 by the circulating pump 43 and thereafter is used again. Accordingly, the carrier liquid contained in the liquid developer is deteriorated every time when the circulating pump 43 is driven once. In view of this point, when calculation is performed in consideration of the deterioration of the carrier liquid in the developing device 16 in addition to the above-described deterioration of the carrier liquid in the separation and extraction device 34, it is possible to acquire more proper resistance of the carrier liquid.

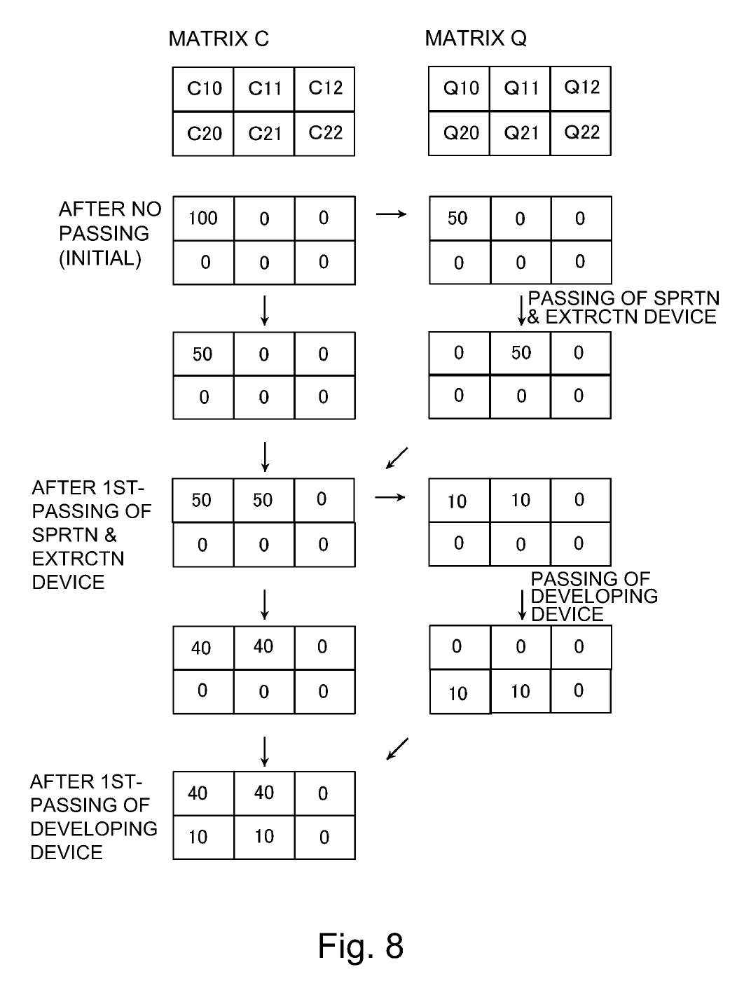

A calculating method of the resistance of the carrier liquid in consideration of the above-described deterioration of the carrier liquid in the separation and extraction device 34 and the deterioration of the carrier liquid in the developing device 16 will be specifically described by a calculation model. In this embodiment, using FIG. 8, the case where each of the separation and collection pump 45 and the circulating pump 43 is driven once will be described. In this embodiment, the case where the circulating pump 43 returns a predetermined amount of the liquid developer into the mixer 31 is counted as one time of drive of the circulating pump 43.

Incidentally, similarly as the above-described First Embodiment, the carrier liquid amount does not increase and decrease before and after the drive of the separation and collection pump 45, and the liquid amount of the carrier liquid fed by single drive of the separation and collection pump 45 is 50 ml and the liquid amount of the carrier liquid accommodated in the carrier tank 32 is 100 ml. Further, the liquid amount of the carrier liquid supplied from the mixer 31 to the developing device 16 by single drive of the developer supplying pump 44 and the liquid amount of the carrier liquid returned from the developing device 16 to the mixer 31 by the circulating pump 43 at that time are equal to each other. That is, the carrier liquid amount does not increase and decrease before and after the drive of the circulating pump 43. Further, the liquid amount of the carrier liquid fed by the single drive of each of the developer supplying pump 44 and the circulating pump 43 is 20 ml.

As shown in FIG. 8, as a calculation model, a matrix C with m rows and n columns, in which the liquid amount of the carrier liquid in the carrier tank 32 is assigned is used (In FIG. 8, only two rows and three columns are shown). At first row and first column of the matrix C, as a “liquid amount by passing of no time” in which the carrier liquid does not pass through the separation and collection pump 45 even one time, an entire amount of the carrier liquid amount in the carrier tank 32 is assigned. Then, every time when the separation and collection pump 45 is driven one time (every time when the carrier liquid passes through the separation and extraction device 34 one time, the “liquid amount for each number of times of passing” is successively assigned for elements moving the columns. This has already been described above and will be omitted from description here. After the separation and collection pump 45 is driven once, a matrix C “50, 50, 0” is provided (after single passing of the carrier liquid through the separation and extraction device “AFTER 1ST-PASSING OF SRRTN & EXTRCTN DEVICE” of FIG. 8).

Then, every time when the circulating pump 43 is driven once (every time when the carrier liquid passes through the developing device 16 once), a “liquid amount of each number of times of passing” of the carrier liquid which passed through the developing device 16 is successively assigned for an element moving an associated row. That is, a “liquid amount in which carrier liquid passed one time through developing device 16” is assigned for second row during drive of one time of the circulating pump 43, a “liquid amount in which carrier liquid passed two times through developing device 16” is assigned for second row during drive of two times of the circulating pump 43, and a “liquid amount in which carrier liquid passed three times through developing device 16” is assigned for third row during drive of three times of the circulating pump 43.

As shown in FIG. 8, in the case where the circulating pump 43 is driven once after the single drive of the separation and collection pump 45, the matrix C is such that the first row is “40, 40, 0” and the second row is “10, 10, 0” (after single passing of the carrier liquid through the developing device “AFTER 1ST-PASSING OF DEVELOPING DEVICE” of FIG. 8). In FIG. 8, first row and first column represents a “liquid amount in which carrier liquid passed no time through separation and extraction device 34” and first row and second column represent a “liquid amount in which carrier liquid passed one time through separation and extraction device 34”. In FIG. 8, second row and first column represent a “liquid amount in which carrier liquid passed no time through separation and extraction device 34 and passed one time through developing device 16” and second row and second column represents a “liquid amount in which carrier liquid passed one time through separation and extraction device 34 and passed one time through developing device 16”.

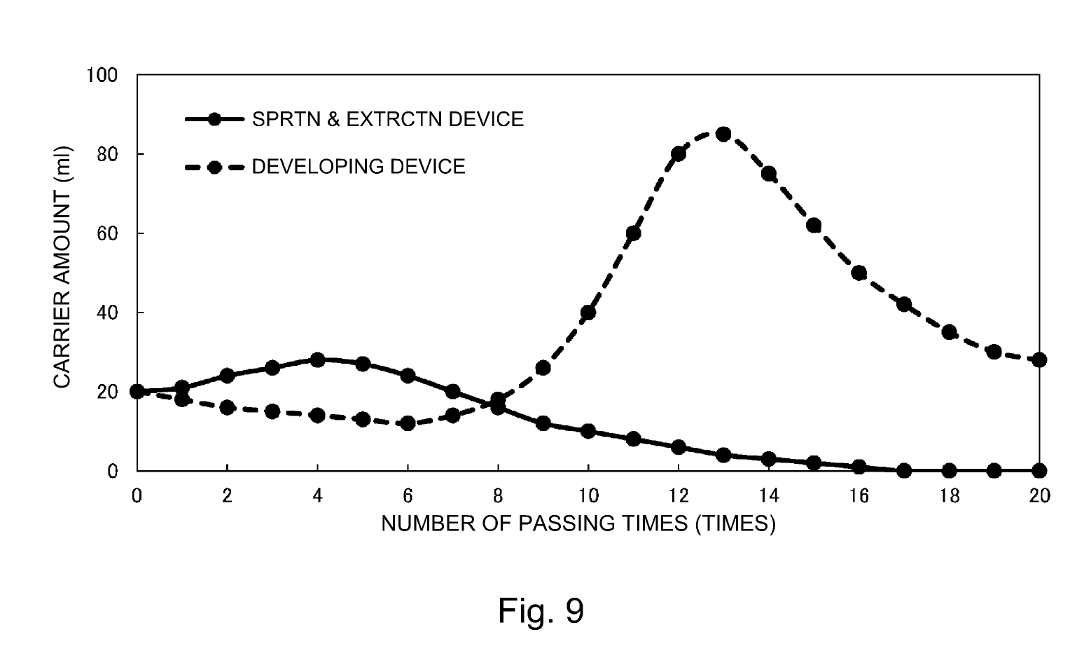

In the above-described manner, calculation of the “liquid amount for each number of times of passing” of the carrier liquid contained in the carrier liquid in the carrier tank 32 is performed every time when each of the separation and collection pump 45 and the circulating pump 43 is driven once. In FIG. 9, an example of the “liquid amount for each number of times of passing (NUMBER OF PASSING TIMES (TIMES))” in the case where each of the separation and collection pump 45 and the circulating pump 43 is driven twenty times is shown.

The “liquid amount for each number of times of passing” shown in FIG. 9 represents as a whole a distribution such that how many amount of the carrier liquid which has passed through each of the separation and extraction device 34 and the developing device 16 what times exists in the carrier tank 32. As can be understood from FIG. 9, in the case where the carrier liquid is passed through the developing device 16, after eight times, compared with the case where the carrier liquid is passed through the separation and extraction device 34, a proportion occupied by the deteriorated carrier liquid increases remarkably. This is because the toner is consumed in the developing device 16 and compared with the separation and extraction device 34, a high-voltage application time is long and correspondingly the ionized charge control agent generates in a large amount.

Further, the resistance of the carrier liquid is calculated using the resistance assigned in advance for each of elements of the matrix C and the “liquid amount for each number of times of passing” of the above-described matrix C. The resistance of the carrier liquid for each number of times of passing of the carrier liquid through the separation and extraction device 34 and for each number of times of passing of the carrier liquid through the developing device 16 is already been stored in the memory 201. The resistance of the carrier liquid is proportional to the number of times of passing of the carrier liquid through the developing device 16 and lowers to for example 1/4 of the resistance of the carrier liquid before the passing for each single passing. The resistance of the carrier liquid at each of the elements of the matrix C shown in FIG. 8 is for example such that first row and first column to first row and third column are successively “1.0E+14 Ωcm”, “0.5E+14 Ωcm” and “0.025E+14 Ωcm”. Further, second row and first column to second row and third column are successively “0.025E+14 Ωcm”, “0.125E+14 Ωcm” and “0.0625E+14 Ωcm”. The controller 200 calculates the resistance of the carrier liquid on the basis of the “liquid amount for each number of times of passing” and these values of the resistance.

As described above, also in this case, the resistance of the carrier liquid used when whether or not the carrier liquid for supply should be supplied is discriminated is acquired by the calculation. However, when the resistance is calculated, not only the ionization of the charge control agent by the separation and extraction device 34 but also the influence of the ionization of the charge control agent by the developing device 16 are taken into consideration, so that a fluctuation in resistance due to the ionized charge control agent contained in the carrier liquid was reflected in the calculation. According to this, it is possible to acquire more proper resistance of the carrier liquid.

### Second Embodiment

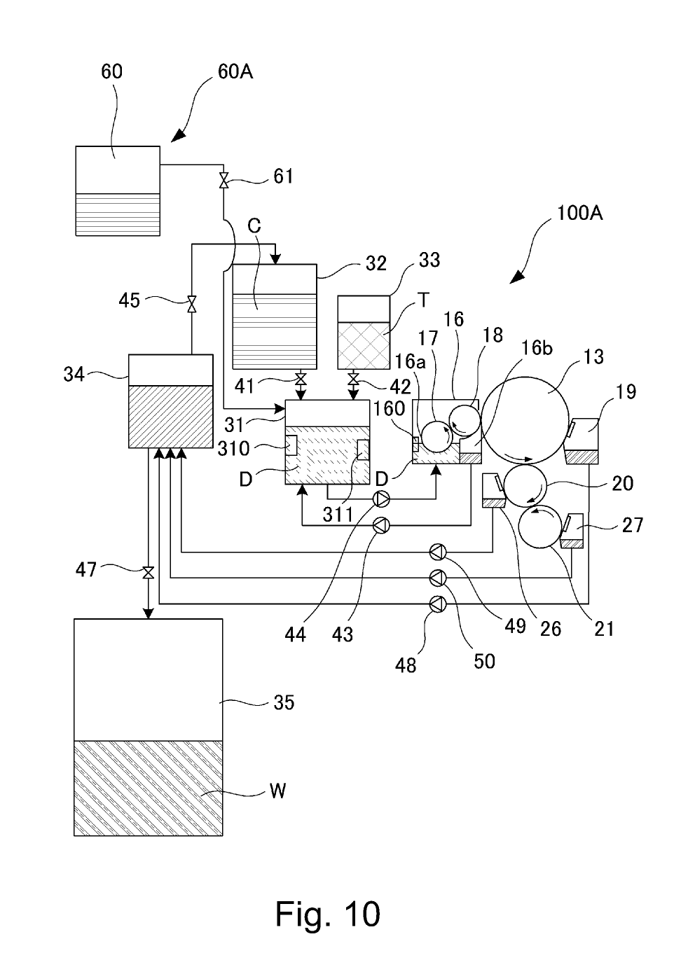

Second Embodiment of the present invention will be described using FIG. 10. In the above-described First Embodiment, the carrier liquid for supply was supplied from the supplying device 36A to the carrier tank 32. On the other hand, in an image forming apparatus 100A of Second Embodiment, the carrier liquid for supply is supplied from a supplying device 60A to the mixer 31. Other basic constitutions and actions are similar to those in First Embodiment, and therefore in the following, the same constitutions will be omitted from description or illustration or will be briefly described, and a portion different from First Embodiment will be principally described.

Also in the case of this embodiment, the separation and extraction device 34, the carrier tank 32 for accommodating the carrier liquid separated by the separation and extraction device 34, and the mixer 31 to which the carrier liquid is supplied from the carrier tank 32 are provided. Further, in this embodiment, the supplying device 60A for supplying the carrier liquid for supply to the mixer 31 is provided. The supplying device 60A includes a supplying carrier tank 60 and a supplying pump 61 provided to a communication pipe for establishing communication between the supplying carrier tank 60 and the mixer 31.

The supplying device 60A supplies the carrier liquid for supply on the basis of the resistance of the carrier liquid in the carrier tank 32. Similarly as in the above-described First Embodiment, also in this embodiment, the resistance of the carrier liquid in the carrier tank 32 is acquired by calculation. Then, in the case where the resistance of the carrier liquid is lower than a predetermined value, the supplying pump 61 is driven, so that the carrier liquid for supply is supplied from the supplying carrier tank 60 to the mixer 31.

### Other Embodiments

Incidentally, in the case where the carrier liquid for supply is supplied, a supply amount may only be required to be added to the “liquid amount by passing of no time” at first row and first column of the matrix C. Therefore, by using the matrix C after the supply amount is added, calculation of the “liquid amount for each number of times of passing” is carried out as described above. When this is briefly described using FIG. 6 as an example, in the case where for example, 20 ml of the carrier liquid for supply is supplied after two times of passing, a value of the matrix C at first row and first column is changed from “25” to “45” obtained by adding “20” which is the supply amount to “25”.

On the other hand, in the case where the carrier liquid is consumed during development, from each of the elements of the matrix Q, a liquid amount corresponding to an equally divided consumption amount may only be required to be subtracted. Therefore, by using the matrix Q after the consumption amount is subtracted, calculation of the “liquid amount for each number of times of passing” is carried out as described above. When this is briefly described using FIG. 8 as an example, in the case where for example, 6 ml of the carrier liquid is consumed both values of the matrix Q at second row and first column and second row and second column are changed from “10” to “7” obtained by subtracting “3”, which is an equally divided consumption amount, from “10”.

Incidentally, in the case where the number of times of passing of the carrier liquid through the developing device 16 is taken into consideration during calculation of the resistance of the carrier liquid, calculation of the “liquid amount for each number of times of passing” of the carrier liquid through the developing device 16 was carried out every time when the circulating pump 43 is driven once, but the present invention is not limited thereto. For example, the calculation of the “liquid amount for each number of times of passing” of the carrier liquid through the developer supplying pump 44, in place of the circulating pump 43, may also be carried out every time when the developer supplying pump 44 is driven once.

### INDUSTRIAL APPLICABILITY

According to the present invention, there is provided an image forming apparatus in which the volume resistivity of the carrier liquid is acquired by calculation and supply control of the carrier liquid for supply is carried out on the basis of this.

### EXPLANATION OF SYMBOLS

12 . . . image forming portion, 13 . . . drum (image bearing member), 16 . . . developing device, 31 . . . mixing device (mixer), 32 . . . carrier container (carrier tank), 33 . . . toner container (toner tank), 34 . . . separating device (separation and extraction device), 36A (60A) . . . supplying device, 43 . . . returning portion (circulating pump), 44 . . . first supplying portion (developer supplying pump), 45 . . . second supplying portion (separation and collection pump), 100 (100A) . . . image forming apparatus, 200 . . . controller (control portion), 300 . . . calculating portion (operation part), 320 . . . liquid amount detecting portion (float sensor)

1. An image forming apparatus comprising:
an image forming portion for forming an image with a liquid developer containing toner and a carrier liquid;
a separating device for separating the liquid developer collected from said image forming portion into the toner and the carrier liquid under application of a voltage;
a toner container for accommodating toner for supply;
a carrier container for accommodating the carrier liquid separated by said separating device;
a mixing device for mixing the carrier liquid supplied from said carrier container with the toner for supply supplied from said toner container;
a supplying device for supplying, to said carrier container, a carrier liquid for supply having a resistance value higher than a predetermined resistance value;
a first supplying portion for supplying the liquid developer from said mixing device to said image forming portion;
a second supplying portion for supplying the carrier liquid from said separating device to said carrier container;
a calculating portion for calculating a value relating to volume resistivity of the carrier liquid in said carrier container on the basis of a supplying operation of said second supplying portion; and
a controller for causing said supplying device to supply the carrier liquid for supply therefrom to said carrier container in order to adjust the volume resistivity of the carrier liquid in said carrier container on the basis of the value relating to the volume resistivity of the carrier liquid acquired by said calculating portion.

2. An image forming apparatus according to claim 1, when a case that said second supplying portion supplies the carrier liquid in a predetermined amount corresponds to one time of a drive, said calculating portion calculates a value relating to the volume resistivity of the carrier liquid in said carrier container depending on a number of times of the drive.

3. An image forming apparatus according to claim 1, wherein said image forming portion includes an image bearing member and a developing device for developing, with the liquid developer, an electrostatic latent image formed on the image bearing member,
wherein said first supplying portion supplies the liquid developer from said mixing device to said developing device,
wherein said image forming apparatus includes a returning portion for returning the liquid developer from said developing device to said mixing device, and
wherein said calculating portion counts a case that said returning portion returns the liquid developer in a predetermined amount as corresponding to one time of a drive of said returning portion and acquires the volume resistivity of the carrier liquid in said carrier container on the basis of a number of times of the drive of said second supplying portion and a number of times of the drive of said returning portion.

4. An image forming apparatus according to claim 1, wherein the carrier liquid includes a charge control agent having a polarity opposite to a polarity of the toner.

5. An image forming apparatus according to claim 2, wherein in a case that the number of times of the drive per unit time is large, said controller causes said supplying device to supply the carrier liquid for supply therefrom to said carrier container in order to adjust the volume resistivity of the carrier liquid in said carrier container.

6. An image forming apparatus comprising:
an image forming portion for forming an image with a liquid developer containing toner and a carrier liquid;
a separating device for separating the liquid developer collected from said image forming portion into the toner and the carrier liquid under application of a voltage;
a toner container for accommodating toner for supply;
a carrier container for accommodating the carrier liquid separated by said separating device;
a mixing device for mixing the carrier liquid supplied from said carrier container with the toner for supply supplied from said toner container;
a supplying device for supplying, to said mixing device, a carrier liquid for supply;
a first supplying portion for supplying the liquid developer from said mixing device to said image forming portion;
a second supplying portion for supplying the carrier liquid from said separating device to said carrier container;
a calculating portion for calculating a value relating to volume resistivity of the carrier liquid in said carrier container on the basis of a supplying operation of said second supplying portion; and
a controller for causing said supplying device to supply the carrier liquid for supply therefrom to said mixing device in order to adjust the volume resistivity of the carrier liquid in said carrier container on the basis of the value relating to the volume resistivity of the carrier liquid acquired by said calculating portion.

7. An image forming apparatus according to claim 6, when a case that said second supplying portion supplies the carrier liquid in a predetermined amount corresponds to one time of a drive, said calculating portion calculates a value relating to the volume resistivity of the carrier liquid in said carrier container depending on a number of times of the drive.

8. An image forming apparatus according to claim 6, wherein said image forming portion includes an image bearing member and a developing device for developing, with the liquid developer, an electrostatic latent image formed on the image bearing member,
wherein said first supplying portion supplies the liquid developer from said mixing device to said developing device,
wherein said image forming apparatus includes a returning portion for returning the liquid developer from said developing device to said mixing device, and
wherein said calculating portion counts a case that said returning portion returns the liquid developer in a predetermined amount as corresponding to one time of a drive of said returning portion and acquires the volume resistivity of the carrier liquid in said carrier container on the basis of a number of times of the drive of said second supplying portion and a number of times of the drive of said returning portion.

9. An image forming apparatus according to claim 6, wherein the carrier liquid includes a charge control agent having a polarity opposite to a polarity of the toner.

10. An image forming apparatus according to claim 7, wherein in a case that the number of times of the drive per unit time is large, said controller causes said supplying device to supply the carrier liquid for supply therefrom to said carrier container in order to adjust the volume resistivity of the carrier liquid in said carrier container.
